(19) United States
(12) Patent Application Publication
(10) Pub. No.: US 2025/0020480 A1
(43) Pub. Date: Jan. 16, 2025

(54) SYSTEM AND METHOD FOR SEGMENTING AUTONOMY MAPS

(71) Applicant: Mercedes-Benz Group AG, Stuttgart (DE)

(72) Inventor: Maximilian MUFFERT, Sunnyvale, CA (US)

(21) Appl. No.: 18/221,560

(22) Filed: Jul. 13, 2023

(51) Int. Cl. G01C 21/00; G06V 10/764; G06V 10/82

(52) U.S. Cl. CPC G01C 21/3815; G01C 21/3848; G01C 21/3885; G06V 10/764; G06V 10/82

(57) ABSTRACT

A computing system can execute a map segmentation engine on an autonomy map of a road network, where the autonomy map is recorded by one or more vehicles operating throughout the road network. Based on executing the map segmentation engine on the autonomy map, the system can classify a set of road network features in the autonomy map to (i) segment the autonomy map into a plurality of class areas, and (ii) associate each respective class area of the plurality of class areas with one or more parameters that regulate a manner in which vehicles operate through the respective class area.

### BACKGROUND

Autonomous and semi-autonomous vehicles operating on road networks may require highly detailed and labeled autonomy maps for real-time localization, which can correspond to estimations of a vehicle's location and orientation within a surrounding environment.

### SUMMARY

A computing system is described herein for segmenting autonomy maps into class areas. In various examples, the computing system can execute a map segmentation engine on an autonomy map of a road network, where the autonomy map is recorded by one or more vehicles operating throughout the road network. Based on executing the map segmentation engine on the autonomy map, the computing system can classify a set of road network features in the autonomy map to segment the autonomy map into a plurality of class areas, and associate each class area with one or more parameters that regulate a manner in which vehicles operate through the respective class area.

In certain implementations, the plurality of class areas can correspond to residential areas, highway driving areas, urban driving areas, rural driving areas, business areas, multi-lane driving zones, caution areas, school zones, multi-tiered density zones, narrow-lane zones, suburban areas, pedestrian-heavy zones, low-speed driving zones, wildlife crossing zones, and the like. In further implementations, the parameters that regulate the manner in which vehicles operate through the class areas can comprise alert limits that govern vehicle operation in the class areas. These alert limits can indicate a maximum allowable error in a measured position of autonomous or semi-autonomous vehicles operating within the respective class area.

For example, freeways that have relatively large lanes, separated directional travel, and large shoulders can allow for increased position error without sacrificing safety. Accordingly, the alert limits for autonomous vehicles on freeways that meet these criteria may be relaxed. On the other hand, dense urban driving environments with heavy pedestrian and bicycle traffic may require absolute minimal position error for vehicles to ensure all entities can traverse their respective travel paths safely. In these operating environments, the alert limits for autonomous vehicles can be established for this minimum error in the autonomy map. In accordance with examples described herein, the alert limit for each class area can be associated with that class area in the autonomy map, such that when an autonomous or semi-autonomous vehicle enters the class area, it automatically adjusts its alert limit accordingly.

In certain embodiments, execution of the map segmentation engine can comprise executing a plurality of probability density functions on the autonomy map. Each probability density function can be configured to detect a set of road network features in the autonomy map. These road network features can comprise poles (e.g., lamp poles, utility poles, traffic signal poles, etc.), traffic signage, traffic signals, road markings along the road network, building facades, trees, foliage, power lines and power infrastructure, curbs, parking spaces, static vehicles, fences, and the like. Each probability density function can be trained with automated or manually labeled autonomy maps that provide the probability density function with indicators of the road network features.

In certain aspects, the autonomy maps can include image data of the road network. In such examples, execution of the map segmentation engine can comprise rasterizing the image data of the autonomy map, and can further involve execution of a convolutional neural network to perform semantic segmentation on the rasterized image data to classify the set of road network features. Additionally or alternatively, the computing system can generate a graphical representation of the autonomy map, and can further execute a graph neural network to perform node classification on the graphical representation of the autonomy map to classify feature representations of the road network. These feature representations can correspond to lane segments, road segments, poles, traffic signage, traffic signals, road markings, etc. In such examples, the computing system can segment the autonomy map into the plurality of class areas based on classifying these feature representations.

According to examples described herein, the segmented autonomy map can be utilized by advanced driver assistance systems of vehicles operating throughout the road network (e.g., semi-autonomous vehicles), and/or can be utilized by fully autonomous vehicles for autonomously driving throughout the road network without human assistance. The segmented autonomy map can comprise any combination of LIDAR data, image data, radar data, ultrasonic data, and the like. Furthermore, upon segmenting the autonomy map into class areas, the computing system can distribute the segmented autonomy map to vehicles that are to operate within the road network.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system for segmenting autonomy maps, in accordance with examples described herein;

FIG. 2 is a block diagram illustrating a computing system including specialized modules for segmenting autonomy maps, according to examples described herein;

FIG. 3 is a diagram illustrating a road network in which an autonomy map has been segmented, according to examples described herein; and

FIGS. 4, 5, 6A, and 6B are flow charts describing example methods of segmenting autonomy maps into class areas, in accordance with the various examples described herein.

### DETAILED DESCRIPTION

Advance driver assistance systems (ADAS) and autonomous driving systems may rely on high-definition maps (hereinafter “autonomy maps”) to allow safe autonomous driving for a given region. As provided herein, an autonomy map or autonomous driving map can comprise a ground truth map recorded by a mapping vehicle using various sensors (e.g., LIDAR sensors and/or a suite of cameras or other imaging devices) and labeled (manually or automatically) to indicate traffic objects, right-of-way rules, and other driving rules for any given location. In variations, an autonomy map can involve reconstructed scenes using decoders from encoded sensor data recorded and compressed by vehicles.

For example, a given autonomy map can be human-labeled based on observed traffic signage, traffic signals, and lane markings in the ground truth map. In further examples, reference points or other points of interest may be further labeled on the autonomy map for additional assistance to the autonomous vehicle. Autonomous vehicles or self-driving vehicles may then utilize the labeled autonomy maps to perform localization, change detection, and various other operations required for autonomous driving on public roads. For example, an autonomous vehicle can reference an autonomy map for determining the traffic rules (e.g., the speed limit) at the vehicle's current location, and can dynamically compare live sensor data from an on-board sensor suite with a corresponding autonomy map to safely navigate along a current route.

It is contemplated that autonomy maps comprise rich digital entities compared to standard navigation maps, and can include lane geometry and topology information and labeled landmarks and features (e.g., signs, traffic lights, barriers, building facades and outlines, sensor specific layers, etc.). Certification processes of ADAS and autonomous driving systems (e.g., by safety authorities) may follow ISO safety standards, which include safety of intended functionality (SOTIF), automotive safety integrity level (ASIL), and functional safety standards. These may require alert limits (e.g., maximum allowable error in the measured position of the vehicle) based on the operational design domain (ODD) of the environment in which particular vehicles will operate. For example, autonomous trucks that will primarily operate on interstate freeways may have relaxed alert limits as compared to autonomous taxis that will operate in urban environments.

According to various embodiments described herein, a computing system can implement probability density functions, graph neural networks, and/or convolutional neural networks to process autonomy maps comprising recorded sensor data of a travel path network for any given area. Utilizing one or more of these processes, the computing system can identify road network features such as poles, signage, and signals to segments portions of the autonomy map into class areas. When the autonomy map is segmented into class areas in accordance with the techniques described herein, certain rules may be imparted on the autonomy map based on the class area, such as alert limit rules.

In certain implementations, the computing system can perform one or more functions described herein using a learning-based approach, such as by executing an artificial neural network (e.g., a recurrent neural network, convolutional neural network, etc.) or one or more machine-learning models to process the respective set of trajectories and classify the driving behavior of each human-driven vehicle through the intersection. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer-programs, or a computer usable carrier medium capable of carrying such a program.

### Example Computing System

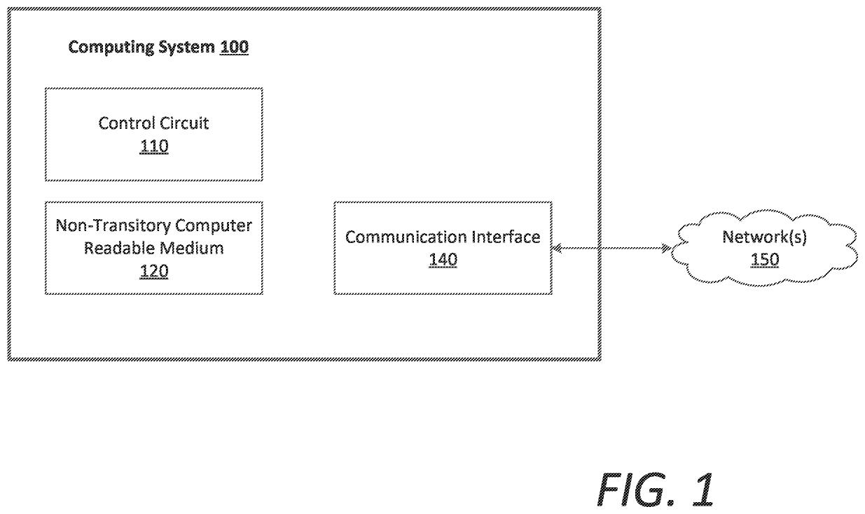

FIG. 1 is a block diagram depicting an example computing system for generating a fused environment representation for a vehicle, according to examples described herein. In an embodiment, the computing system 100 can include a control circuit 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 110 and/or computing system 100 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, or any other controller (the term “or” is used herein interchangeably with “and/or”). In variations, the control circuit 110 and/or computing system 100 can be included on one or more servers (e.g., backend servers).

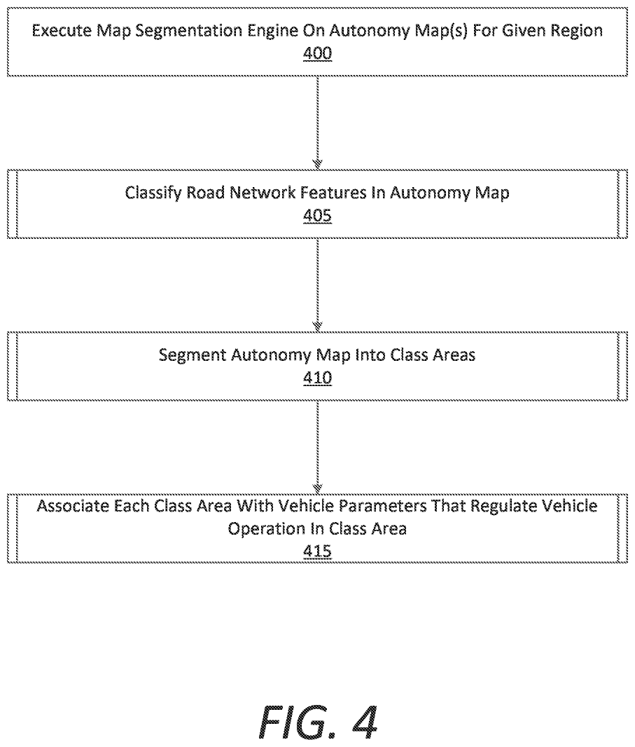

In an embodiment, the control circuit 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 4, 5, 6A, and 6B.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when a control circuit 110 or other hardware component is executing the modules or computer-readable instructions.

In further embodiments, the computing system 100 can include a communication interface 140 that enables communications over one or more networks 150 to transmit and receive data. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can comprise a backend computing system 100 that can execute a map segmentation engine on an autonomy map of a road network. As provided herein, the autonomy map can be recorded by one or more vehicles operating throughout the road network (e.g., specialized ground truth recording vehicle or consumer-driven vehicle that include the necessary sensors to record autonomy maps). Based on executing the map segmentation engine on the autonomy map, the computing system 100 can classify a set of road network features in the autonomy map to segment the autonomy map into a plurality of class areas and associate each class area with one or more parameters that regulate a manner in which vehicles operate through the respective class area. The class areas can correspond to residential areas, highway driving areas, urban driving areas, rural driving areas, and the like. In various implementations described herein, these parameters can include aspects such as alert limits for autonomous driving within the class area.

### System Description

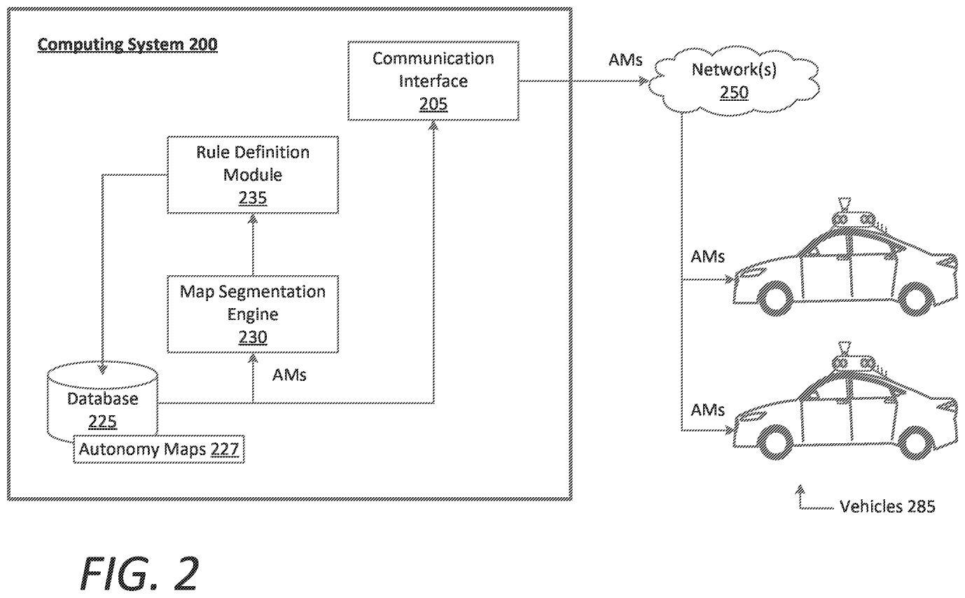

FIG. 2 is a block diagram illustrating a computing system including specialized modules for segmenting autonomy maps, according to examples described herein. In certain examples, the computing system 200 can include a communication interface 205 to enable the computing system 200 to communicate over one or more networks 250. In various implementations, the computing system 200 can include a database 225 comprise autonomy maps 227 corresponding to a given road network in which vehicles operate. As provided herein, the road network can comprise public roads, highways, freeways, alleyways, etc., each including various infrastructure components for controlling traffic, such as signage, traffic signals, road markings, and the like.

In some embodiments, the autonomy maps 227 can be labeled to indicate various landmarks and road rules at any given location (e.g., speed limits, right-of-way rules, stop signs, traffic signals, etc.), and can comprise any other information provided for autonomous vehicle operation throughout the road network. Alternatively, certain autonomy maps 227 can comprise recorded ground-truth sensor data (e.g., any single or combination of image data, LIDAR data, radar data, etc.) without labels.

In various implementations, the computing system 200 can include a map segmentation engine 230 that can process the autonomy maps 227 in accordance with the techniques described herein. These techniques can include classical approaches, such as executing a plurality of probability density functions on the autonomy map 227, where each probability density function can be configured to detect a set of road network features in the autonomy map 227. These road network feature can comprise poles (e.g., lamp poles, utility poles, traffic signal poles, etc.), traffic signage, traffic signals, building facades, trees, power infrastructure, and the like. For example, a probability density function may identify objects such as poles along a particular roadway in the autonomy map 227 using Kernel density estimation. Additionally, another probability density function can be trained or otherwise configured to detect traffic lights. As provided herein, the map segmentation engine 230 can combine the probability density functions to segment the autonomy map 227.

As further provided herein, each probability density function can be trained with automated or manually labeled autonomy maps that provide the probability density function with indicators of various road network features. In combination, the plurality of probability density functions can output a multi-dimensional probability density of the various road network features within the autonomy map 227. Based on the locations and density of these road network features, the map segmentation engine 230 can segment that autonomy map 227 into class areas in the manner described herein.

In certain variations, the autonomy map 227 can include image data of the road network. In such examples, the map segmentation engine 230 can rasterize the image data of the autonomy map 227, and execute a convolutional neural network to perform semantic segmentation on the rasterized image data to classify certain road network features (e.g., using pixel-wise classification). These features can include poles, traffic signage, traffic signals, etc., but can also include road and lane markings to provide further context with regard to the driving environment, such as lane width, shoulder size, driveways, parking lot entrances, and the like.

Additionally or alternatively, the map segmentation engine 230 can generate a graphical representation of the autonomy map 227, and execute a graph neural network to perform node classification on the graphical representation of the autonomy map 227 to identify and classify feature representations of the road network features. In such examples, the roads and/or lanes may be linked by their topology, and other features such as crosswalks, stop signs, etc. can be connected with their adjacent lanes.

In various examples, the map segmentation engine 230 can perform any one technique or a combination of the foregoing techniques to identify road network features and segment the autonomy map 227 into class areas. As described herein, the class areas can correspond to a range of alert levels at which humans naturally operate their vehicles in terms of collision avoidance behavior (e.g., reduction in speed, increased braking behavior, etc.), common areas of distracted driving (e.g., on larger, wider streets and highways), and everything in between. As such, the segmented autonomy maps 227 based on the techniques performed by the map segmentation engine 230 can be attributed to one or more rules for autonomous driving.

According to examples described herein, the computing system can include a rule definition module 235 that can append one or more rules to each class area of the autonomy map 227 based on the parsing performed by the map segmentation engine 230. The one or more rules can regulate a manner in which vehicles operate through the class area. As described herein, the map segmentation engine 230 can classify the autonomy map 227 into a plurality of class areas, which can correspond to residential areas, highway driving areas, urban driving areas, rural driving areas, business areas, multi-lane driving zones, caution areas, school zones, narrow-lane zones, suburban areas, pedestrian-heavy zones, low-speed driving zones, wildlife crossing zones, or any combination of the foregoing. As an example, a narrow, tree-lined residential street with low lateral visibility may be relatively devoid of pedestrians at any given time, and yet the rule definition module 235 may place maximum alert limit requirements due to the low lateral visibility.

In various implementations, the rule definition module 235 can establish an alert limit for each class area as defined by the map segmentation engine 230. The alert limit can define a maximum allowable error in a measured position of autonomous or semi-autonomous vehicles operating within the class area. As an example, a freeway may have relatively large lanes, separated directional travel, and large shoulders that can allow for increased position error without sacrificing safety. For this class area, the rule definition module 235 can establish a relatively relaxed alert limit for autonomous vehicles. As another example, the map segmentation engine 230 may identify road network features in a certain area that indicates dense urban driving environment with a high probability of heavy pedestrian and bicycle traffic (e.g., bike lanes, abundant crosswalks and pedestrian signals, narrow driving lanes, etc.). In this class area, the rule definition module may require absolute minimal position error for autonomous vehicles.

According to various embodiments, the rule definition module 235 can establish the autonomous vehicle rules associated with each class area in each autonomy map 227 as segmented by the map segmentation engine 230. As such, the autonomy maps 227 can be amended and/or labeled with these rules by the combined techniques performed by the map segmentation engine 230 and rule definition module 235. In certain examples, the computing system 200 can communicate, over one or more networks 250, with autonomous and/or semi-autonomous vehicles 285 that operate along mapped roads that correspond to the autonomy maps 227. As such, the computing system 200 can transmit, using the communication interface 205, the updated autonomy maps 227 to the vehicles 285.

Thereafter, the vehicles 285 may utilize the updated autonomy maps 227 to alter their operational behaviors when crossing into class areas, as defined by the rule definition module 235. One such behavior can comprise adjusting the alert limit of the vehicle 285 when crossing into a new class area. It is contemplated that smaller, more precise alert limits may require increased computing power by the vehicle's on-board computing system, and can therefore cause the vehicle to operate more slowly and with increased caution. It is further contemplated that vehicles 285 implementing adjustable alert limits can increase the operational design domains through which those vehicles 285 may operate autonomously. In various examples, the segmented autonomy maps 227 can be utilized by advanced driver assistance systems of vehicles operating throughout the road network (e.g., semi-autonomous vehicles), and/or can be utilized by fully autonomous vehicles for autonomously driving throughout the road network without human assistance.

### Example Segmented Autonomy Map

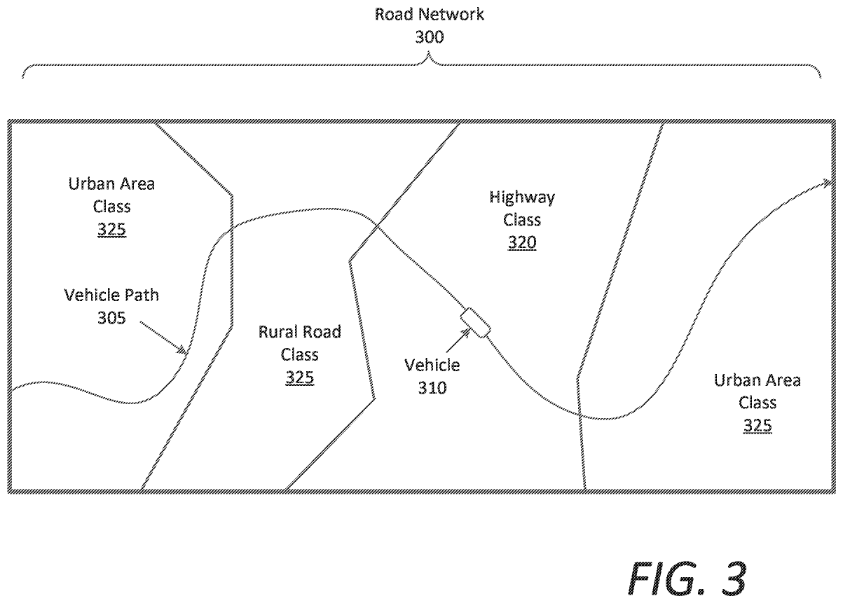

FIG. 3 is a diagram illustrating a road network 300 in which a corresponding autonomy map 227 has been segmented, according to examples described herein. The road network 300 can comprise any combination of roads, streets, freeways, highways, alleyways, on-ramps, off-ramps, parking areas, etc. As described above, the autonomy map 227 corresponding to the road network 300 can be segmented into class areas by the map segmentation engine 230 and may be imparted with respective sets of rules based on the class areas by the rule definition module 235. Furthermore, the road network 300 corresponding to an autonomy map 227 is provided for purposes of illustration, and is not intended to limit the various embodiments provided herein.

Referring to FIG. 3, an autonomous vehicle 310 can traverse the road network 300 using one or more autonomy maps that have been segmented into class areas and imparted with operative rules. The vehicle path 305 of the autonomous vehicle 310 can include a sequence of multiple roads along an overall route. At the start of the vehicle path 305, the autonomous vehicle 310 traverses an urban area class 325 that includes a set of operative rules for the autonomous vehicle 310 while the autonomous vehicle 310 is within the urban area (e.g., a city or township). One such operative rule can comprise a set alert limit for operating through the urban area class 325.

As the vehicle 310 continues to traverse the vehicle path 305, the vehicle 310 can enter a rural road class 325, which includes a different set of operative rules than the urban area class 325. As the vehicle 310 enters the rural road class 325, the vehicle 310 can adjust its alert limit in accordance with the set of operative rules for the rural road class 325. Likewise, as the vehicle 310 traverses the vehicle path 305 into the highway class 320 and then back into an urban area class 325, the vehicle 310 can conform to the respective sets of operative rules associated with each when operating through each of these areas. As provided throughout the present disclosure, one of these operative rules can comprise the alert limit associated with the class area through which the vehicle 310 traverses.

### Methodology

FIGS. 4, 5, 6A, and 6B are flow charts describing example methods of segmenting autonomy maps into class areas, in accordance with the various examples described herein. In the below descriptions of FIGS. 4, 5, 6A, and 6B, reference may be made to reference characters representing various features as shown and described with respect to FIGS. 1 and 2. Furthermore, the processes described in connection with FIGS. 4, 5, 6A, and 6B may be performed by an example computing system 200 as described with respect to FIG. 2. Further still, certain steps described with respect to the flow charts of FIGS. 4, 5, 6A, and 6B may be performed prior to, in conjunction with, or subsequent to any other step, and need not be performed in the respective sequences shown.

Referring to FIG. 4, at block 400, the computing system 200 can execute a map segmentation engine 230 on a set of autonomy maps 227 for a given region. As described herein, the given region can comprise any driving region that includes travels paths for vehicles. At block 405, execution of the map segmentation engine 230 can cause the computing system 200 classify road network features in the autonomy maps 227. These road network features can include various poles, road signs, traffic signs and signals, road and lane markings, and the like.

At block 410, the computing system 200 can then segment the autonomy map 227 into class areas or driving zones. As provided herein, these class areas or driving zones can include residential areas, highway driving areas, an urban driving area, rural driving areas, and multi-lane driving areas. In further implementations, the class areas or driving zones can include business areas, multi-lane driving zones, caution areas, school zones, multi-tiered density zones, narrow-lane zones, suburban areas, pedestrian-heavy zones, low-speed driving zones, wildlife crossing zones, and the like. At block 415, the computing system 200 can associate each class area with a set of vehicle parameters that regulate vehicle operation in the class area. In certain implementations, these vehicle parameters can involve a reallocation of computing resources to object detection, perception, and motion prediction operations, and/or may involve maximum and/or minimum allowable speeds depending on the class area. Additionally or alternatively, the vehicle parameters can include an alert limit attributed to each particular class area, which comprises a maximum allowable error in a measured position of the autonomous or semi-autonomous vehicle operating within the respective class area.

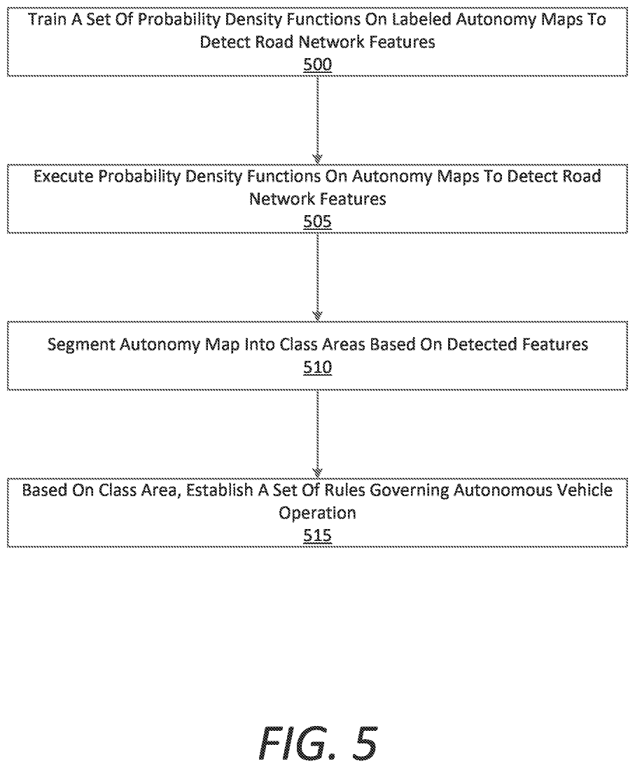

FIG. 5 is a flow chart describing the use of probability density functions for segmenting autonomy maps, in accordance with examples described herein. Referring to FIG. 5, at block 500, the computing system 200 can facilitate in training a set of probability density functions on labeled autonomy maps to detect specified road network features. In various examples, a particular probability density function may be trained to identify and determine the density of poles along roadsides. Other probability density functions may be trained to detect and determine the density of signage, traffic signals, power infrastructure, building facades, trees and other foliage, and the like. As described here, each of these road network features and their respective or combined densities can be indicative of the necessary caution required in traversing through class areas corresponding to these features.

At block 505, the computing system 200 can execute the probability density functions on autonomy maps 227 to detect the road network features recorded on these autonomy maps 227. At block 510, based on the density of the detected road network features, the computing system 200 can segment the autonomy map 227 into class areas, in the manners described above. At block 515, based on the class area, the computing system 200 can establish a set of rules for governing autonomous vehicle operation within the class area within the autonomy map 227.

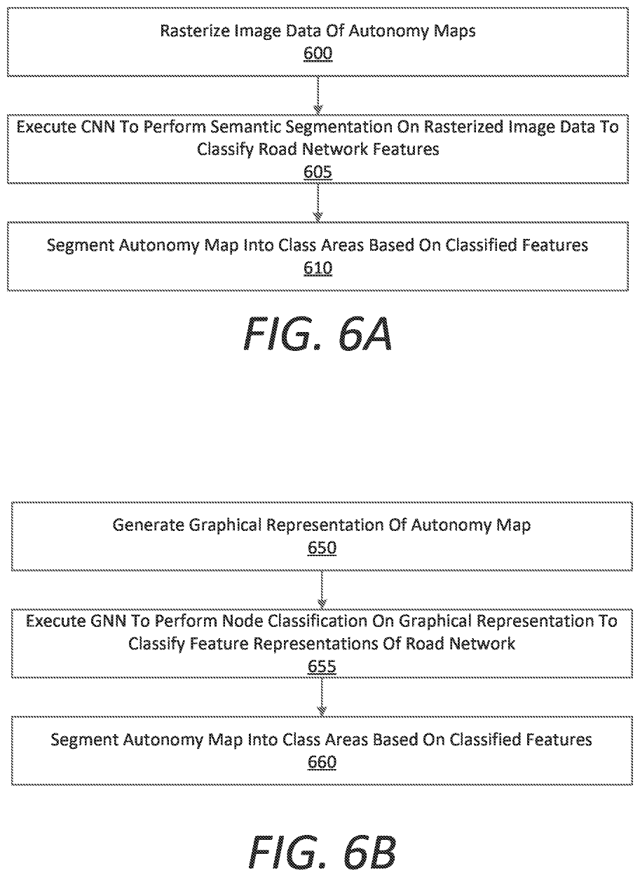

FIG. 6A is a flow chart describing an example method of segmenting autonomy maps based on image data, according to examples described herein. Referring to FIG. 6A, at block 600, the computing system 200 can rasterize image data of the autonomy maps 227. At block 605, in various examples, the computing system 200 can execute a convolutional neural network or other suitable learned-based technique to perform semantic segmentation on the rasterized image data to classify road network features in the image data. As with other examples described herein, these road network features can include poles, signage, signals, etc., and/or can include road markings, such as crosswalks, lane hashes, colored lines (e.g., yellow or double yellow directional lane dividers, turning lane markers, shoulder markings, parking space markers, and the like. At block 610, the computing system 200 may then segment the autonomy map 227 into class areas based on the classified features and their respective densities.

FIG. 6B is a flow chart describing an example method of segmenting autonomy maps based on graphical representations, in accordance with examples described herein. Referring to FIG. 6B, at block 650, the computing system 200 can generate a graphical representation of an autonomy map 227. At block 655, in various examples, the computing system 200 can execute a graphical neural network or other suitable learned-based technique to perform node classification on the graphical representation of the autonomy map 227 to classify feature representations of the road network. Based on these classifications, the computing system 200 can determine the locations and density of road network features in the autonomy map 227. At block 660, the computing system 200 map then segment the autonomy map 227 into class areas based on the classified features.

As provided herein, any single method or combination of methods may be used to perform the map segmentation techniques described herein. It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system comprising:
one or more processors; and
a memory storing instructions that, when executed by the one or more processors, cause the computing system to:
execute a map segmentation engine on an autonomy map of a road network, the autonomy map being recorded by one or more vehicles operating throughout the road network; and
based on executing the map segmentation engine on the autonomy map, classify a set of road network features in the autonomy map to (i) segment the autonomy map into a plurality of class areas, and (ii) associate each respective class area of the plurality of class areas with one or more parameters that regulate a manner in which vehicles operate through the respective class area.

2. The computing system of claim 1, wherein the plurality of class areas correspond to a plurality of the following: (i) a residential area, (ii) a highway driving area, (iii) an urban driving area, or (iv) a rural driving area.

3. The computing system of claim 2, wherein the one or more parameters that regulate the manner in which vehicles operate through the respective class area comprise an alert limit governing vehicle operation in the respective class area.

4. The computing system of claim 3, wherein the alert limit indicates a maximum allowable error in a measured position of a vehicle operating within the respective class area.

5. The computing system of claim 1, wherein execution of the map segmentation engine comprises executing a plurality of probability density functions on the autonomy map, each probability density function being configured to detect a set of road network features in the autonomy map.

6. The computing system of claim 5, wherein the road network features comprise a plurality of the following: (i) poles, (ii) traffic signage, (iii) traffic signals, or (iv) road markings along the road network.

7. The computing system of claim 5, wherein each probability density function of the plurality of probability density functions is trained with automated or manually labeled autonomy maps that indicate the set of road network features.

8. The computing system of claim 2, wherein the autonomy map includes image data of the road network, and wherein execution of the map segmentation engine comprises:
rasterizing the image data of the autonomy map; and
executing a convolutional neural network to perform semantic segmentation on the rasterized image data to classify the set of road network features in the image data in order to segment the autonomy map into the plurality of class areas.

9. The computing system of claim 1, wherein execution of the map segmentation engine comprises:
generating a graphical representation of the autonomy map; and
executing a graph neural network to perform node classification on the graphical representation of the autonomy map to classify feature representations of the road network.

10. The computing system of claim 9, wherein the feature representations of the road network correspond to one or more of the following: (i) lane segments, (ii) road segments, (iii) poles, (iv) traffic signage, (v) traffic signals, or (iv) road markings of the road network.

11. The computing system of claim 9, wherein the executed instructions cause the computing system to segment the autonomy map into the plurality of class areas based, at least in part, on classifying the feature representations of the road network.

12. The computing system of claim 1, wherein the segmented autonomy map is utilized by an advanced driver assistance system (ADAS) of vehicles operating throughout the road network.

13. The computing system of claim 1, wherein the segmented autonomy map is utilized by autonomous vehicles to autonomously drive throughout the road network.

14. The computing system of claim 1, wherein the autonomy map comprises any combination of LIDAR data, image data, radar data, and ultrasonic data.

15. The computing system of claim 1, wherein the executed instructions further cause the computing system to:
distribute the segmented autonomy map to vehicles that are to operate within the road network, the vehicles comprising at least one of semi-autonomous vehicles or fully autonomous vehicles.

16. A non-transitory computer readable medium storing instructions that, when executed by one or more processors of a computing system, cause the computing system to:
execute a map segmentation engine on an autonomy map of a road network, the autonomy map being recorded by one or more vehicles operating throughout the road network; and
based on executing the map segmentation engine on the autonomy map, classify a set of road network features in the autonomy map to (i) segment the autonomy map into a plurality of class areas, and (ii) associate each respective class area of the plurality of class areas with one or more parameters that regulate a manner in which vehicles operate through the respective class area.

17. The non-transitory computer readable medium of claim 16, wherein the plurality of class areas correspond to a plurality of the following: (i) a residential area, (ii) a highway driving area, (iii) an urban driving area, or (iv) a rural driving area.

18. The non-transitory computer readable medium of claim 17, wherein the one or more parameters that regulate the manner in which vehicles operate through the respective class area comprise an alert limit governing vehicle operation in the respective class area.

19. The non-transitory computer readable medium of claim 18, wherein the alert limit indicates a maximum allowable error in a measured position of a vehicle operating within the respective class area.

20. A computer-implemented method of segmenting autonomy maps, the method being performed by one or more processors and comprising:
executing a map segmentation engine on an autonomy map of a road network, the autonomy map being recorded by one or more vehicles operating throughout the road network; and
based on executing the map segmentation engine on the autonomy map, classifying a set of road network features in the autonomy map to (i) segment the autonomy map into a plurality of class areas, and (ii) associate each respective class area of the plurality of class areas with one or more parameters that regulate a manner in which vehicles operate through the respective class area.
